(19) United States
(12) Patent Application Publication
(10) Pub. No.: US 2026/0048458 A1
(43) Pub. Date: Feb. 19, 2026

(54) MECHANICAL ARM FOR NUT DETACHMENT AND INSTALLATION AND USE METHOD THEREOF

(71) Applicants: GUANGDONG POWER GRID CO., LTD., Guangzhou (CN); Heyuan Power Supply Bureau Of Guangdong Power Grid Corporation, Heyuan (CN); ELECTRIC POWER RESEARCH INSTITUTE OF GUANGDONG POWER GRID CO., LTD., Guangzhou (CN)

(72) Inventors: Jiangfeng QIAO, Heyuan (CN); Peijie LIU, Heyuan (CN); Tuo ZENG, Heyuan (CN); Xiaolong BI, Heyuan (CN); Yongqin LI, Heyuan (CN); Jingfang YOU, Heyuan (CN); Ruizhi LUO, Heyuan (CN); Hao HUANG, Heyuan (CN); Guojun LI, Heyuan (CN); Ben SU, Heyuan (CN)

(21) Appl. No.: 18/983,735

(22) Filed: Dec. 17, 2024

(30) Foreign Application Priority Data
Aug. 14, 2024 (CN) 202411115569.2

(51) Int. Cl. B23P 19/06; B25J 19/02

(52) U.S. Cl. CPC B23P 19/06; B25J 19/023

(57) ABSTRACT

Provided are a mechanical arm for nut detachment and installation and a use method thereof, which belong to the technical field of nut detachment and installation on power transmission lines. The mechanical arm for nut detachment and installation includes a frame, a slide assembly, a detachment and installation device, and a visual camera, where the slide assembly is disposed in the frame and slidable in the frame, the visual camera is adjustable in position and disposed on the frame, the detachment and installation device is connected to the slide assembly and configured to detach or install a nut once or nuts continually, the visual camera is configured to identify and feed back x-axis, y-axis, and z-axis coordinates of the nut to the slide assembly, and the slide assembly is configured to drive the detachment and installation device to move to the coordinates of the nut.

### CROSS-REFERENCE TO RELATED APPLICATION(S)

This application claims priority to Chinese Patent Application No. 202411115569.2 filed Aug. 14, 2024, the disclosure of which is incorporated herein by reference in its entirety.

### TECHNICAL FIELD

The present disclosure relates to the technical field of nut detachment and installation on power transmission lines and, in particular, to a mechanical arm for nut detachment and installation and a use method thereof.

### BACKGROUND

Presently, the working environment of overhead high-voltage power lines is relatively harsh. For example, wire vibration due to ice coverage, breeze vibration, or other reasons may cause a loose nut on a drainage plate of a strain clamp. In the case where the nut is not in solid contact, the resistance on a line increases. Thus, the temperature of the drainage plate rises, and the oxidation of a contact surface between the nut and the drainage plate is accelerated, resulting in the burning of the drainage plate and the breaking of a wire. This has a great impact on the safe and stable operation of a power grid. In the related art, nuts of such strain clamps are mainly detached and tightened manually at a ground potential or equipotential. Not only is this method limited by the distance of live working, but also the nuts cannot be tightened under insufficient torque, making it difficult for an operator to operate. Moreover, climbing by being hooked and hung on a rope ladder is necessary for equipotential operation. Can detachment be performed only after a pulley is hung and a tension rope and an arc-quenching rope are tied on a drainage line. Then, the drainage line needs to be recovered before the operator climbs down the rope ladder. Finally, the site is restored. The above detachment and installation workflow is complicated and time-consuming, and the equipotential operation is highly dangerous. Therefore, how to ensure the reliability, safety, and intelligence of nut detachment and installation on the drainage plate of the strain clamp and reduce an operation risk is a problem to be solved currently by persons in the art.

### SUMMARY

An object of the present disclosure is to provide a mechanical arm for nut detachment and installation and a use method thereof, so as to ensure the reliability, safety, and intelligence of nut detachment and installation on a drainage plate of a strain clamp and reduce an operation risk.

To achieve the object, the present disclosure adopts the technical solutions below.

A mechanical arm for nut detachment and installation includes a frame, a slide assembly, a detachment and installation device, and a visual camera.

The slide assembly is disposed in the frame and slidable in the frame, the visual camera is adjustable in position and disposed on the frame, the detachment and installation device is connected to the slide assembly and configured to detach or install a nut once or nuts continually, the visual camera is configured to identify and feed back x-axis, y-axis, and z-axis coordinates of the nut to the slide assembly, and the slide assembly is configured to drive the detachment and installation device to move to the coordinates of the nut.

Optionally, the detachment and installation device includes a drive mechanism and a sleeve assembly, the drive mechanism is fixed on the slide assembly, the sleeve assembly is connected to an output end of the drive mechanism, and the sleeve assembly is configured to be sleeved on and clamp the outer side of the nut.

Optionally, the sleeve assembly includes a sleeve fixing base, a sleeve body, claws, and first elastic members, a side of the sleeve fixing base is connected to the drive mechanism, the other side of the sleeve fixing base is fixedly connected to the sleeve body, the claws are movably disposed on the sleeve body and elastically connected to the sleeve fixing base through the first elastic members, and the claws are configured to elastically abut against the outer side of the nut.

Optionally, the sleeve body is provided with a receiving groove and inclined wedge grooves, the receiving groove is connected with the inclined wedge grooves, the claws are movably disposed in the inclined wedge grooves, and the nut is located in the receiving groove and is configured to push the claws to extend out of the inclined wedge grooves.

Optionally, a second elastic member is further provided in the receiving groove, the second elastic member is located between the nut and the bottom of the receiving groove, and the second elastic member has smaller elasticity than each of the first elastic members.

Optionally, the slide assembly includes a y-axis slide, an x-axis slide, and a z-axis slide, the z-axis slide is disposed at the bottom of the frame and slidably connected to the frame, the x-axis slide is disposed on the z-axis slide, and the y-axis slide is disposed on the x-axis slide and connected to the detachment and installation device.

Optionally, the y-axis slide is provided with a first baseplate, first fixing bases, a first drive assembly, a first transmission assembly, and a connecting seat, the first baseplate is connected to the x-axis slide, the first fixing bases are disposed on the first baseplate, the first drive assembly and the first transmission assembly are connected to the first fixing bases, the connecting seat is disposed on the first transmission assembly and connected to the detachment and installation device, and the first drive assembly is configured to drive, through the first transmission assembly, the connecting seat to move along a y axis.

Optionally, the x-axis slide is provided with a second baseplate, second fixing bases, a second drive assembly, and a second transmission assembly, the second baseplate is connected to the z-axis slide, the second fixing bases are disposed on the second baseplate, the second drive assembly and the second transmission assembly are connected to the second fixing bases, the y-axis slide is disposed on the second transmission assembly, and the second drive assembly is configured to drive, through the second transmission assembly, the y-axis slide to move along an x axis.

Optionally, the z-axis slide is provided with a third leadscrew, a third electric motor, and a guide assembly, the guide assembly is slidably connected to a baseplate of the frame, the x-axis slide is connected to the guide assembly, the third electric motor is disposed on the baseplate, the third leadscrew is connected to the third electric motor, and the third electric motor is configured to drive, through the third leadscrew, the x-axis slide to move along a z axis.

In another aspect, a use method of a mechanical arm for nut detachment and installation includes the steps below.

The mechanical arm for nut detachment and installation is installed on a connecting rod of a clamp through a clip module.

A visual camera identifies coordinates of a nut to be detached and feeds data back to a slide assembly.

The slide assembly drives a detachment and installation device to move to the coordinates of the nut to be detached, and the detachment and installation device is sleeved on and clamps the outer side of the nut to be detached to perform detachment.

The visual camera identifies coordinates of the next nut to be detached, and the above steps are repeated so that the detachment and installation device is sleeved on and clamps the outer side of the next nut to be detached and presses the previous nut to be detached into the detachment and installation device to perform detachment.

The above steps are repeated until all nuts are detached, where all the nuts are drawable out of the detachment and installation device.

The above steps are repeated reversely so that a nut of the nuts is installed.

The present disclosure has the beneficial effects below.

In the present disclosure, the visual camera can identify and record a coordinate position of the nut and feed the coordinate position back to the slide assembly, and the slide assembly can position the detachment and installation device. Specifically, in the case where the x-axis, y-axis, and z-axis coordinates of the nut are determined, the slide assembly can move the detachment and installation device to the coordinates of the nut so that the accuracy and automation effect of nut detachment and installation can be improved, manual operation in the related art can be effectively avoided, and the safety, reliability, and intelligence of the entire operation can be improved. Accordingly, the detachment and installation device can detach or install the nut once or the nuts continually and thus can automatically remove the nut and store multiple nuts detached or to be installed, preventing the nuts from being repeatedly accessed and improving the detachment and installation efficiency. Similarly, the use method of the mechanical arm for nut detachment and installation can also ensure the reliability, safety, and intelligence of nut detachment and installation on the drainage plate of the strain clamp and effectively reduce the operation risk.

### BRIEF DESCRIPTION OF DRAWINGS

FIG. 1 is a structural view of a mechanical arm for nut detachment and installation according to an embodiment of the present disclosure.

FIG. 2 is a schematic view of connections between a mechanical arm for nut detachment and installation, a clip module, and a clamp according to an embodiment of the present disclosure.

FIG. 3 is a structural view of a clamp according to an embodiment of the present disclosure.

FIG. 4 is a schematic isometric view of a mechanical arm for nut detachment and installation according to an embodiment of the present disclosure.

FIG. 5 is another schematic isometric view of a mechanical arm for nut detachment and installation according to an embodiment of the present disclosure.

FIG. 6 is a structural view of a y-axis slide in a mechanical arm for nut detachment and installation according to an embodiment of the present disclosure.

FIG. 7 is a structural view of an x-axis slide in a mechanical arm for nut detachment and installation according to an embodiment of the present disclosure.

FIG. 8 is a structural view of a sleeve assembly in a mechanical arm for nut detachment and installation according to an embodiment of the present disclosure.

FIG. 9 is a front view of a sleeve assembly in a mechanical arm for nut detachment and installation according to an embodiment of the present disclosure.

FIG. 10 is a sectional view of a sleeve assembly in a mechanical arm for nut detachment and installation according to an embodiment of the present disclosure.

### REFERENCE LIST

100 mechanical arm for nut detachment and installation
200 clip module
300 clamp
310 connecting rod
10 frame
20 slide assembly
30 detachment and installation device
40 visual camera
101 fixing block
102 baseplate
21 y-axis slide
22 x-axis slide
23 z-axis slide
31 drive mechanism
32 sleeve assembly
211 first baseplate
212 first fixing base
213 first drive assembly
2131 first motor plate
2132 first electric motor
2133 first driving wheel
2134 first driven wheel
2135 first synchronous belt
2136 tension shaft
214 first transmission assembly
2141 first leadscrew
2142 first slide bar
2143 first moving seat
215 limiting assembly
2151 detection piece
2152 limiting switch
216 connecting seat
221 second baseplate
222 second fixing base
223 second drive assembly
2231 second motor plate
2232 second electric motor
2233 second driving wheel
2234 second driven wheel
2235 second synchronous belt
224 second transmission assembly
2241 second leadscrew
2242 second slide bar
2243 second moving seat
231 third leadscrew
232 third electric motor
233 guide assembly
2331 third slide bar
2332 slide sleeve
301 receiving groove
302 inclined wedge groove
321 sleeve fixing base
322 sleeve body
323 claw
324 first elastic member
325 second elastic member

### DETAILED DESCRIPTION

Embodiments of the present disclosure are described in detail below. Examples of the embodiments are illustrated in the drawings, where the same or similar reference numerals throughout the drawings represent the same or similar components or components having the same or similar functions. The embodiments described below with reference to the drawings are illustrative and intended to explain the present disclosure and cannot be construed as limiting the present disclosure.

In the description of the present disclosure, terms “joined”, “connected”, and “fixed” are to be understood in a broad sense unless otherwise expressly specified and limited. For example, the term “connected” may refer to “fixedly connected” or “detachably connected”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the description of the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

Presently, the working environment of overhead high-voltage power lines is relatively harsh. For example, wire vibration due to ice coverage, breeze vibration, or other reasons may cause a loose nut on a drainage plate of a strain clamp. In the case where the nut is not in solid contact, the resistance on a line increases. Thus, the temperature of the drainage plate rises, and the oxidation of a contact surface between the nut and the drainage plate is accelerated, resulting in the burning of the drainage plate and the breaking of a wire. This has a great impact on the safe and stable operation of a power grid. In the related art, nuts of such strain clamps are mainly detached and tightened manually at a ground potential or equipotential. Not only is this method limited by the distance of live working, but also the nuts cannot be tightened under insufficient torque, making it difficult for an operator to operate. Moreover, climbing by being hooked and hung on a rope ladder is necessary for equipotential operation. Can detachment be performed only after a pulley is hung and a tension rope and an arc-quenching rope are tied on a drainage line. Then, the drainage line needs to be recovered before the operator climbs down the rope ladder. Finally, the site is restored. The above detachment and installation workflow is complicated and time-consuming, and the equipotential operation is highly dangerous. Therefore, how to ensure the reliability, safety, and intelligence of nut detachment and installation on the drainage plate of the strain clamp and reduce an operation risk is a problem to be solved currently by persons in the art.

Technical solutions in this embodiment are further described below through specific implementations in conjunction with the drawings.

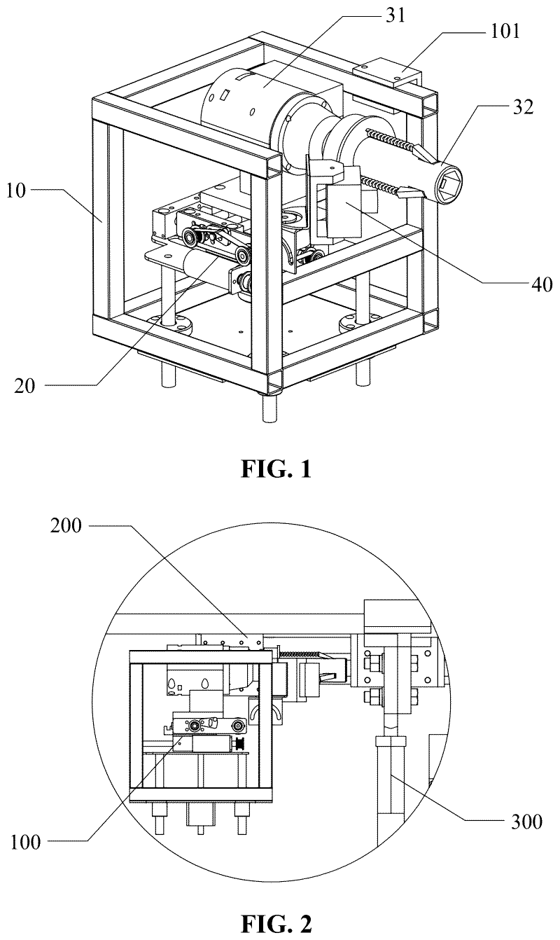

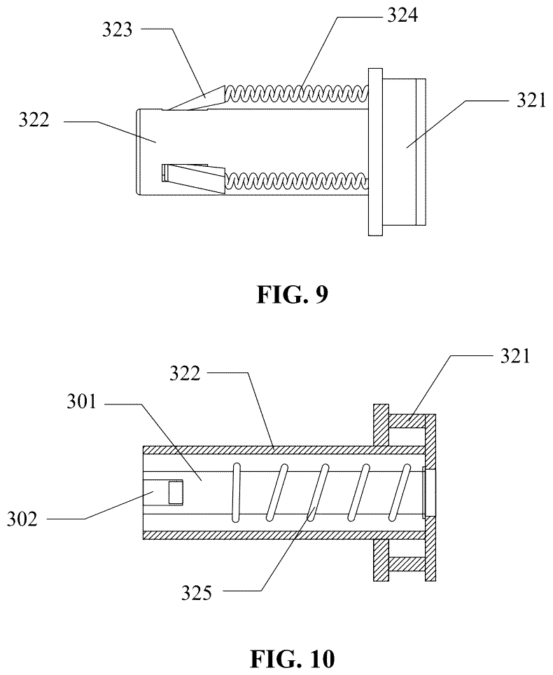

As shown in FIGS. 1 to 10, this embodiment provides a mechanical arm for nut detachment and installation, the mechanical arm includes a frame 10, a slide assembly 20, a detachment and installation device 30, and a visual camera 40. The slide assembly 20 is disposed in the frame 10 and slidable in the frame 10, the visual camera 40 is adjustable in position and disposed on the frame 10, the detachment and installation device 30 is connected to the slide assembly 20 and configured to detach or install a nut once or nuts continually, the visual camera 40 is configured to identify and feed back x-axis, y-axis, and z-axis coordinates of the nut to the slide assembly 20, and the slide assembly 20 is configured to drive the detachment and installation device 30 to move to the coordinates of the nut.

Specifically, in this embodiment, the visual camera 40 can identify and record a coordinate position of the nut and feed the coordinate position back to the slide assembly 20, and the slide assembly 20 can position the detachment and installation device 30. Specifically, in the case where the x-axis, y-axis, and z-axis coordinates of the nut are determined, the slide assembly 20 can move the detachment and installation device 30 to the coordinates of the nut so that the accuracy and automation effect of nut detachment and installation can be improved, manual operation in the related art can be effectively avoided, and the safety, reliability, and intelligence of the entire operation can be improved. Accordingly, the detachment and installation device 30 can detach or install the nut once or the nuts continually and thus can automatically remove the nut and store multiple nuts detached or to be installed, preventing the nuts from being repeatedly accessed and improving the detachment and installation efficiency.

The specific structure of the mechanical arm for nut detachment and installation in this embodiment is described below.

As shown in FIGS. 1 to 3, the mechanical arm for nut detachment and installation 100 in this embodiment is disposed on a connecting rod 310 of a clamp 300. Optionally, the clamp 300 has a T-shaped structure, a clip module 200 is hung on the connecting rod 310, and the mechanical arm for nut detachment and installation 100 is connected to the clip module 200 so that the mechanical arm for nut detachment and installation 100 is hung on the clamp 300. Further, the mechanical arm for nut detachment and installation 100 in this embodiment includes the frame 10, the slide assembly 20, the detachment and installation device 30, and the visual camera 40. Specifically, the slide assembly 20 is disposed in the frame 10 and slidable in the frame 10, and the detachment and installation device 30 is connected to the slide assembly 20. Further, the visual camera 40 is adjustable in position and disposed on the frame 10, and the visual camera 40 can identify and feed back the x-axis, y-axis, and z-axis coordinates of the nut to the slide assembly 20 so that the slide assembly 20 can drive the detachment and installation device 30 to move to the coordinates of the nut, and the detachment and installation device 30 can implement the nut detachment and installation. For example, the mechanical arm for nut detachment and installation 100 in this embodiment can detach or install the nut once or the nuts continually, and the detachment and installation device 30 can store at least two nuts, thereby improving the nut detachment and installation efficiency, implementing automated detachment and installation, and avoiding a waste of manpower.

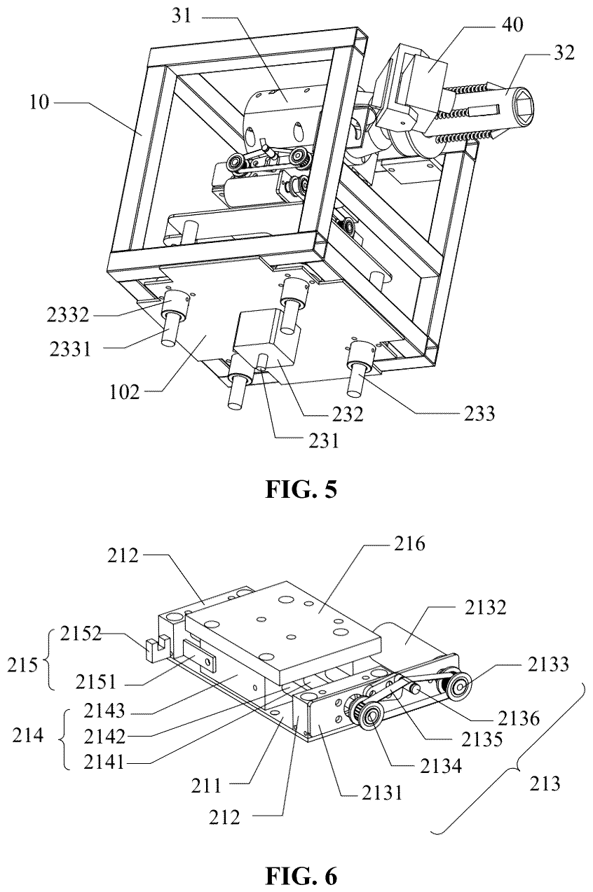

As shown in FIGS. 4 and 5, the frame 10 in this embodiment is provided with a fixing block 101 and a baseplate 102, the fixing block 101 is disposed at the top of the frame 10, and the baseplate 102 is disposed at the bottom of the frame 10. Specifically, in this embodiment, the fixing block 101 is detachably connected to the clip module 200 so that the mechanical arm for nut detachment and installation 100 can be stably connected to the clip module 200. Further, the slide assembly 20 is disposed on the baseplate 102 so that a stable connection between the slide assembly 20 and the frame 10 can be ensured. For example, the frame 10 is configured to have a cubic structure. Further, the visual camera 40 and the detachment and installation device 30 are both located at the top of the frame 10, so as to facilitate the identification of the position of the nut and quick detachment and installation.

Optionally, the slide assembly 20 in this embodiment includes a y-axis slide 21, an x-axis slide 22, and a z-axis slide 23. Specifically, the z-axis slide 23 is disposed at the bottom of the frame 10 and slidably connected to the baseplate 102, the x-axis slide 22 is disposed on the z-axis slide 23, and the y-axis slide 21 is disposed on the x-axis slide 22 and connected to the detachment and installation device 30 so that the detachment and installation device 30 can move along an x axis, a y axis, and a z axis through the x-axis slide 22, the y-axis slide 21, and the z-axis slide 23 and thus move according to a target position determined by the visual camera 40, thereby implementing accurate detachment and installation.

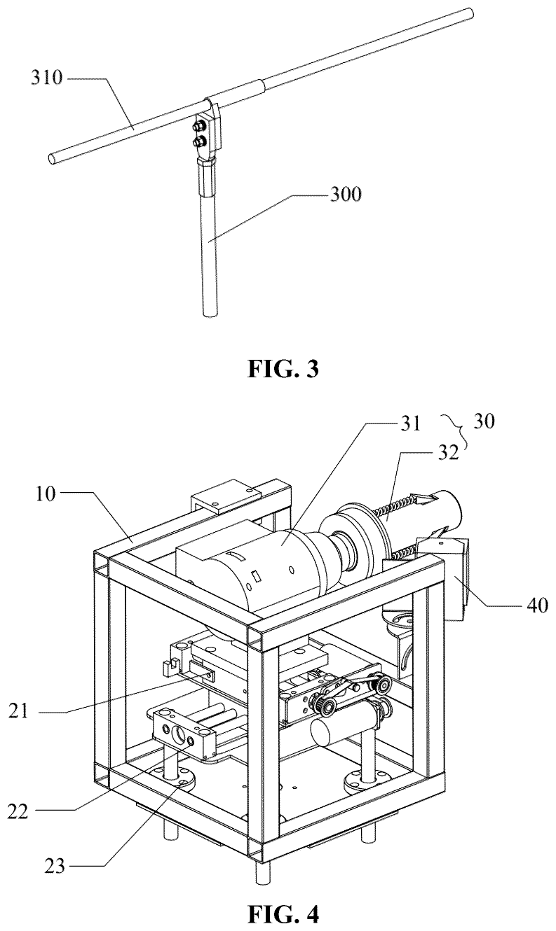

As shown in FIGS. 3 and 6, specifically, the y-axis slide 21 is provided with a first baseplate 211, first fixing bases 212, a first drive assembly 213, a first transmission assembly 214, a limiting assembly 215, and a connecting seat 216, where the first drive assembly 213 includes a first motor plate 2131, a first electric motor 2132, a first driving wheel 2133, a first driven wheel 2134, a first synchronous belt 2135, and a tension shaft 2136, the first transmission assembly 214 includes a first leadscrew 2141, first slide bars 2142, and a first moving seat 2143, and the limiting assembly 215 includes a detection piece 2151 and a limiting switch 2152. Optionally, the first fixing bases 212 are disposed on the first baseplate 211, the first drive assembly 213 and the first transmission assembly 214 are connected to the first fixing bases 212, and the connecting seat 216 is disposed on the first transmission assembly 214 and connected to the detachment and installation device 30 so that and the first drive assembly 213 can drive, through the first transmission assembly 214, the connecting seat 216 to move along the y axis, thereby implementing the movement of the detachment and installation device 30 along the y axis.

Optionally, two first fixing bases 212 are provided, and the two first fixing bases 212 are parallel to each other and spaced apart on the first baseplate 211. Further, the first motor plate 2131 is disposed on one of the first fixing bases 212, and the length of the first motor plate 2131 is greater than the length of a first fixing base 212. For example, the first electric motor 2132 is connected to the first motor plate 2131 and located on a side of the first motor plate 2131 facing the first fixing base 212 and in a region of the first motor plate 2131 exceeding the first fixing base 212, so as to improve the overall space utilization. Further, the first driving wheel 2133, the first driven wheel 2134, and the tension shaft 2136 are all disposed on a side of the first motor plate 2131 facing away from the first fixing base 212, the first driving wheel 2133 is connected to an output end of the first electric motor 2132, and the first driven wheel 2134 is connected to the first driving wheel 2133 through the first synchronous belt 2135 so that when the first electric motor 2132 drives the first driving wheel 2133 to rotate, the first driven wheel 2134 can rotate synchronously with the first driving wheel 2133. Further, the tension shaft 2136 is disposed between the first driving wheel 2133 and the first driven wheel 2134 and abuts against the inner side of the first synchronous belt 2135 to provide tension for the first synchronous belt 2135 and ensure the stability of rotation.

Further, two first slide bars 2142 are provided, the two first slide bars 2142 are parallel to each other and spaced apart, the first leadscrew 2141 is disposed between the two first slide bars 2142, and the first leadscrew 2141 and the two first slide bars 2142 are arranged in parallel. Specifically, the first leadscrew 2141 and the first slide bars 2142 all penetrate through the first moving seat 2143, two ends of each first slide bar 2142 are fixed on the first fixing bases 212 one to one, and two ends of the first leadscrew 2141 are rotatably connected to the first fixing bases 212 one to one. Specifically, an end of the first leadscrew 2141 is connected to the first driven wheel 2134 after penetrating through the first fixing base 212, and the first electric motor 2132 can drive, through the first driving wheel 2133 and the first driven wheel 2134, the first leadscrew 2141 to rotate. For example, the first moving seat 2143 is threadedly connected to the first leadscrew 2141 so that when the first leadscrew 2141 rotates, the first moving seat 2143 can move along a direction of an axis of the first leadscrew 2141. Further, the connecting seat 216 is disposed on the top of the first moving seat 2143, and the detachment and installation device 30 is installed on the connecting seat 216 so that when the first moving seat 2143 moves, the detachment and installation device 30 can move synchronously with the connecting seat 216 to move along the y axis.

For example, the detection piece 2151 is disposed on an edge of a side surface of the first moving seat 2143, and the limiting switch 2152 is disposed on the first fixing base 212 closer to the detection piece 2151 so that a movement range of the first moving seat 2143 on the first leadscrew 2141 can be limited through the arrangement of the detection piece 2151 and the limiting switch 2152. Specifically, the detection piece 2151 is disposed on an edge of a side surface of the first moving seat 2143 facing away from the first electric motor 2132. Specifically, in this embodiment, a position of the first moving seat 2143 is controlled by the revolutions and direction of rotation of an output shaft of the first electric motor 2132.

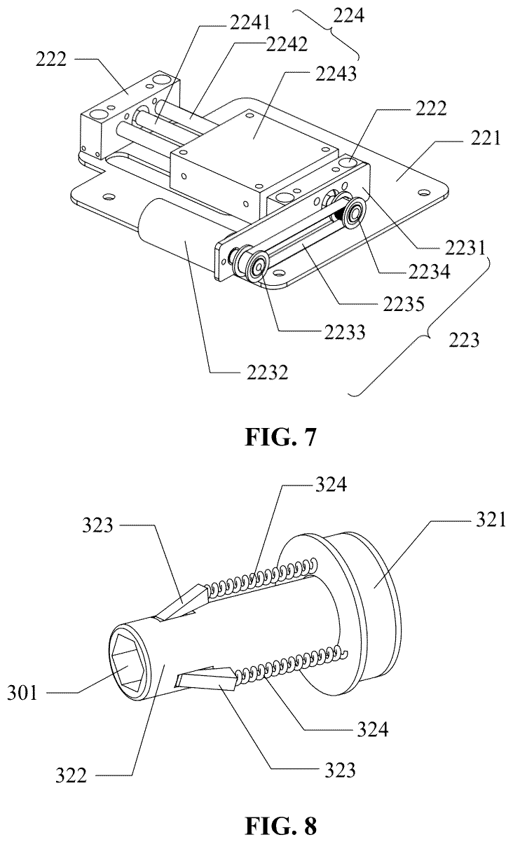

As shown in FIGS. 3 and 7, the x-axis slide 22 in this embodiment is provided with a second baseplate 221, second fixing bases 222, a second drive assembly 223, and a second transmission assembly 224. The second drive assembly 223 includes a second motor plate 2231, a second electric motor 2232, a second driving wheel 2233, a second driven wheel 2234, and a second synchronous belt 2235. The second transmission assembly 224 includes a second leadscrew 2241, second slide bars 2242, and a second moving seat 2243. Optionally, the second baseplate 221 is connected to the z-axis slide 23, the second fixing bases 222 are disposed on the second baseplate 221, the second drive assembly 223 and the second transmission assembly 224 are connected to the second fixing bases 222, and the y-axis slide 21 is disposed on the second transmission assembly 224 so that the second drive assembly 223 can drive, through the second transmission assembly 224, the y-axis slide 21 to move along the x axis, thereby implementing the movement of the detachment and installation device 30 along the x axis.

Optionally, two second fixing bases 222 are provided, and the two second fixing bases 222 are parallel to each other and spaced apart on the second baseplate 221. Further, the second motor plate 2231 is disposed on one of the second fixing bases 222, and the length of the second motor plate 2231 is greater than the length of a second fixing base 222. For example, the second electric motor 2232 is connected to the second motor plate 2231 and located on a side of the second motor plate 2231 facing the second fixing base 222 and in a region of the second motor plate 2231 exceeding the second fixing base 222, so as to improve the overall space utilization. Further, the second driving wheel 2233 and the second driven wheel 2234 are both disposed on a side of the second motor plate 2231 facing away from the second fixing base 222, the second driving wheel 2233 is connected to an output end of the second electric motor 2232, and the second driven wheel 2234 is connected to the second driving wheel 2233 through the second synchronous belt 2235 so that when the second electric motor 2232 drives the second driving wheel 2233 to rotate, the second driven wheel 2234 can rotate synchronously with the second driving wheel 2233. Correspondingly, a tension structure may be disposed between the second driving wheel 2233 and the second driven wheel 2234 to ensure transmission stability, which is not repeated here.

Further, two second slide bars 2242 are provided, the two second slide bars 2242 are parallel to each other and spaced apart, the second leadscrew 2241 is disposed between the two second slide bars 2242, and the second leadscrew 2241 and the two second slide bars 2242 are arranged in parallel. Specifically, the second leadscrew 2241 and the second slide bars 2242 all penetrate through the second moving seat 2243, two ends of each second slide bar 2242 are fixed on the second fixing bases 222 one to one, and two ends of the second leadscrew 2241 are rotatably connected to the second fixing bases 222 one to one. Specifically, an end of the second leadscrew 2241 is connected to the second driven wheel 2234 after penetrating through the second fixing base 222, and the second electric motor 2232 can drive, through the second driving wheel 2233 and the second driven wheel 2234, the second leadscrew 2241 to rotate. For example, the second moving seat 2243 is threadedly connected to the second leadscrew 2241 so that when the second leadscrew 2241 rotates, the second moving seat 2243 can move along a direction of an axis of the second leadscrew 2241. Further, the first baseplate 211 of the y-axis slide 21 is installed on the second moving seat 2243 so that when the second moving seat 2243 moves, the y-axis slide 21 can move synchronously with the second moving seat 2243, thereby implementing the movement of the detachment and installation device 30 along the x axis. Specifically, in this embodiment, a position of the second moving seat 2243 is controlled by the revolutions and direction of rotation of an output shaft of the second electric motor 2232.

As shown in FIGS. 4 and 5, the z-axis slide 23 in this embodiment is provided with a third leadscrew 231, a third electric motor 232, and a guide assembly 233, where the guide assembly 233 includes third slide bars 2331 and slide sleeves 2332. Optionally, the guide assembly 233 is slidably connected to the baseplate 102 of the frame 10, the x-axis slide 22 is connected to the top of the guide assembly 233, the third electric motor 232 is disposed on the baseplate 102 and located under the baseplate 102, and the third leadscrew 231 is connected to the third electric motor 232 so that the third electric motor 232 can drive, through the third leadscrew 231, the x-axis slide 22 to move along the z axis, thereby enabling the y-axis slide 21 and the detachment and installation device 30 to move along the z axis as a whole. Specifically, in this embodiment, four third slide bars 2331 are provided, and the four third slide bars 2331 penetrate through four top corners of the baseplate 102. Accordingly, four slide sleeves 2332 are provided in one-to-one correspondence with the third slide bars 2331. The four slide sleeves 2332 are all fixed on the baseplate 102, so as to ensure the smooth slide between the third slide bars 2331 and the baseplate 102.

Specifically, in this embodiment, the third electric motor 232 is configured to be a stepper motor. Thus, the third electric motor 232 can drive the third leadscrew 231 to move up and down along an axis of the third leadscrew 231 so that the x-axis slide 22 can be pushed to move along the z axis and can move smoothly under the support and guidance of the third slide bars 2331. For example, limiting devices may also be disposed on the x-axis slide 22 and the z-axis slide 23 to limit respective movement ranges of the x-axis slide 22 and the z-axis slide 23 along the x axis and the z axis. Specifically, in this embodiment, a position of the second baseplate 221 is controlled by the revolutions and direction of rotation of an output shaft of the third electric motor 232.

As shown in FIGS. 1 and 8 to 10, the detachment and installation device 30 in this embodiment includes a drive mechanism 31 and a sleeve assembly 32. The sleeve assembly 32 includes a sleeve fixing base 321, a sleeve body 322, claws 323, first elastic members 324 and a second elastic member 325, and the sleeve body 322 is provided with a receiving groove 301 and inclined wedge grooves 302. Optionally, the drive mechanism 31 is fixed on the y-axis slide 21 of the slide assembly 20, the sleeve assembly 32 is connected to an output end of the drive mechanism 31, and the sleeve assembly 32 can be sleeved on and clamp the outer side of the nut so that the mechanical arm for nut detachment and installation 100 can stably clamp the nut, thereby implementing quick detachment and installation. For example, in this embodiment, the drive mechanism 31 includes an electric motor and a gear reduction device, and the sleeve assembly 32 is connected to the gear reduction device so that when the electric motor drives the gear reduction device, the sleeve assembly 32 can be rotated with different effects to tighten or loosen the nut to implement the nut detachment and installation. Further, a cam is provided at the output end of the drive mechanism 31, and the cam can move up and down when the sleeve assembly 32 rotates so that the cam can rotate at a high speed and generate a certain impact force, and the impact force can be transmitted to the nut through the sleeve assembly 32 to implement rapid rotation or loosening.

As shown in FIGS. 8 to 10, in this embodiment, a side of the sleeve fixing base 321 is connected to the drive mechanism 31, the other side of the sleeve fixing base 321 is fixedly connected to the sleeve body 322, and the claws 323 are movably disposed on the sleeve body 322 and elastically connected to the sleeve fixing base 321 through the first elastic members 324. Specifically, the sleeve body 322 is provided with the receiving groove 301 and the inclined wedge grooves 302, the receiving groove 301 is connected with the inclined wedge grooves 302, and the claws 323 are movably disposed in the inclined wedge grooves 302 and do not fall off the inclined wedge grooves 302. Further, during the nut detachment and installation, the nut is located in the receiving groove 301 and can push the claws 323 to extend out of the inclined wedge grooves 302, and the claws 323 can elastically abut against the outer side of the nut under the action of the first elastic members 324 so that the nut is locked in position.

For example, in this embodiment, four inclined wedge grooves 302 are provided, and the four inclined wedge grooves 302 are evenly arranged with an axis of the sleeve body 322 as the center. Further, the first elastic members 324 are configured to be springs, located on the outer side of the sleeve body 322, and disposed in one-to-one correspondence with the claws 323, and the claws 323 are disposed in one-to-one correspondence with the inclined wedge grooves 302 so that the outer side of the nut is elastically supported at multiple points to ensure the stable clamping of the nut. Further, the second elastic member 325 is disposed in the receiving groove 301. During the nut detachment and installation, the second elastic member 325 is located between the nut and the bottom of the receiving groove 301 and applies an outward thrust to the nut to ensure that the nut stably abuts against the sleeve body 322, thereby improving the detachment and installation efficiency. Meanwhile, during the detachment and installation of multiple nuts, each nut being operated on can be guaranteed to be stably clamped by the claws 323. For example, in this embodiment, the second elastic member 325 has smaller elasticity than each first elastic member 324 to avoid a clamping failure of the claws 323. Further, in this embodiment, the shape of the receiving groove 301 is adapted to the shape of the nut, so as to prevent the nut from slipping in the receiving groove 301 during the detachment and installation.

For example, in this embodiment, the visual camera 40 can capture the nut on the clamp 300, calculate three-dimensional coordinates of the nut by using a corresponding algorithm, and feed back the coordinates to the slide assembly 20 so that the detachment and installation device 30 can accurately reach target coordinates. Moreover, during the nut detachment and installation, the visual camera 40 is connected to the slide assembly 20 to ensure the accurate position and flexible movement of the detachment and installation device 30.

### Embodiment Two

This embodiment provides a use method of a mechanical arm for nut detachment and installation. Components identical or corresponding to those in embodiment one use the corresponding reference numerals in embodiment one. For the sake of simplicity, only differences between embodiment two and embodiment one are described. The differences are described below.

The use method of the mechanical arm for nut detachment and installation includes the steps below.

A mechanical arm for nut detachment and installation 100 is installed on a connecting rod 310 of a clamp 300 through a clip module 200.

A visual camera 40 identifies coordinates of a nut to be detached and feeds data back to a slide assembly 20.

The slide assembly 20 drives a detachment and installation device 30 to move to the coordinates of the nut to be detached, and the detachment and installation device 30 is sleeved on and clamps the outer side of the nut to be detached to perform detachment.

The visual camera 40 identifies coordinates of the next nut to be detached, and the above steps are repeated so that the detachment and installation device 30 is sleeved on and clamps the outer side of the next nut to be detached and presses the previous nut to be detached into the detachment and installation device 30 to perform detachment.

The above steps are repeated until all nuts are detached, where all the nuts are drawable out of the detachment and installation device 30.

The above steps are repeated reversely so that a nut can be installed.

Specifically, in this embodiment, the visual camera 40 identifies the coordinates of the nut to be detached so that the detachment and installation device 30 can automatically move to target coordinates to perform the nut detachment and installation. Compared with manual operation in the related art, the use method has higher efficiency and safety.

For example, when the detachment and installation device 30 is sleeved on the outer side of the nut to be detached, the outer side of the nut to be detached applies an outward force to claws 323 to cause the claws 323 to extend out of inclined wedge grooves 302, and under the action of first elastic members 324, the claws 323 apply an inward force to the outer side of the nut so that under the action of multiple claws 323, the nut can be guaranteed to be stably clamped in a receiving groove 301. Then, the nut can be detached through a drive mechanism 31. After the nut is loosened, under the action of the first elastic members 324, the claws 323 press inward to press the nut tightly and ensure that the nut does not fall off the receiving groove 301. Accordingly, when the detachment and installation device 30 detaches the next nut to be detached, the next nut to be detached is still located in the receiving groove 301 and can press the previous nut detached until the previous nut detached is disengaged from the claws 323 and compresses a second elastic member 325. At this time, without an outward abutting effect, the claws 323 return to initial positions into the inclined wedge grooves 302 under the action of the first elastic members 324. The next nut to be detached abuts against the claws 323 again, and the claws 323 repeat the above steps to extend out of the inclined wedge grooves 302, so as to stably clamp the nut and detach the nut.

Conversely, during the installation of multiple nuts, an outer nut is tightened through the drive mechanism 31, and then a sleeve assembly 32 is moved backward relative to the nut and away from the installed nut so that the claws 323 lose the outward force and return to the initial positions under the action of the first elastic members 324. Then, an inner nut moves toward an opening of the receiving groove 301 and presses the claws 323 again under the action of the second elastic member 325 so that the claws 323 extend out of the inclined wedge grooves 302 to stably clamp the nut. Installation steps are repeated so that the nut can be installed.

Thus, the detachment and installation device 30 can detach or install the nut once or the nuts continually and can store multiple nuts and ensure that the nuts do not fall out, so as to facilitate recovery after detachment or the installation of multiple nuts at a time, thereby reducing the number of times the nuts are accessed and improving the nut detachment and installation efficiency.

Apparently, the preceding embodiments of the present disclosure are illustrative of the present disclosure and are not intended to limit embodiments of the present disclosure. Those of ordinary skill in the art can make changes or variations in other different forms based on the preceding description. All embodiments cannot be and have no need to be exhausted herein. Any modifications, equivalent substitutions, and improvements made within the spirit and principle of the present disclosure fall within the scope of the claims of the present disclosure.

What is claimed is:

1. A mechanical arm for nut detachment and installation, comprising:
a frame, a slide assembly, a detachment and installation device, and a visual camera;
wherein the slide assembly is disposed in the frame and slidable in the frame, the visual camera is adjustable in position and disposed on the frame, the detachment and installation device is connected to the slide assembly and configured to detach or install a nut once or nuts continually, the visual camera is configured to identify and feed back x-axis, y-axis, and z-axis coordinates of the nut to the slide assembly, and the slide assembly is configured to drive the detachment and installation device to move to the coordinates of the nut.

2. The mechanical arm for nut detachment and installation according to claim 1, wherein the detachment and installation device comprises a drive mechanism and a sleeve assembly, the drive mechanism is fixed on the slide assembly, the sleeve assembly is connected to an output end of the drive mechanism, and the sleeve assembly is configured to be sleeved on and clamp an outer side of the nut.

3. The mechanical arm for nut detachment and installation according to claim 2, wherein the sleeve assembly comprises a sleeve fixing base, a sleeve body, claws, and first elastic members;
a side of the sleeve fixing base is connected to the drive mechanism, another side of the sleeve fixing base is fixedly connected to the sleeve body, the claws are movably disposed on the sleeve body and elastically connected to the sleeve fixing base through the first elastic members, and the claws are configured to elastically abut against the outer side of the nut.

4. The mechanical arm for nut detachment and installation according to claim 3, wherein the sleeve body is provided with a receiving groove and inclined wedge grooves, the receiving groove is connected with the inclined wedge grooves, the claws are movably disposed in the inclined wedge grooves, and the nut is located in the receiving groove and is configured to push the claws to extend out of the inclined wedge grooves.

5. The mechanical arm for nut detachment and installation according to claim 4, wherein a second elastic member is further provided in the receiving groove, the second elastic member is located between the nut and a bottom of the receiving groove, and the second elastic member has smaller elasticity than each of the first elastic members.

6. The mechanical arm for nut detachment and installation according to claim 1, wherein the slide assembly comprises a y-axis slide, an x-axis slide, and a z-axis slide, the z-axis slide is disposed at a bottom of the frame and slidably connected to the frame, the x-axis slide is disposed on the z-axis slide, and the y-axis slide is disposed on the x-axis slide and connected to the detachment and installation device.

7. The mechanical arm for nut detachment and installation according to claim 6, wherein the y-axis slide is provided with a first baseplate, first fixing bases, a first drive assembly, a first transmission assembly, and a connecting seat, the first baseplate is connected to the x-axis slide, the first fixing bases are disposed on the first baseplate, the first drive assembly and the first transmission assembly are connected to the first fixing bases, the connecting seat is disposed on the first transmission assembly and connected to the detachment and installation device, and the first drive assembly is configured to drive, through the first transmission assembly, the connecting seat to move along a y axis.

8. The mechanical arm for nut detachment and installation according to claim 6, wherein the x-axis slide is provided with a second baseplate, second fixing bases, a second drive assembly, and a second transmission assembly, the second baseplate is connected to the z-axis slide, the second fixing bases are disposed on the second baseplate, the second drive assembly and the second transmission assembly are connected to the second fixing bases, the y-axis slide is disposed on the second transmission assembly, and the second drive assembly is configured to drive, through the second transmission assembly, the y-axis slide to move along an x axis.

9. The mechanical arm for nut detachment and installation according to claim 6, wherein the z-axis slide is provided with a third leadscrew, a third electric motor, and a guide assembly, the guide assembly is slidably connected to a baseplate of the frame, the x-axis slide is connected to the guide assembly, the third electric motor is disposed on the baseplate, the third leadscrew is connected to the third electric motor, and the third electric motor is configured to drive, through the third leadscrew, the x-axis slide to move along a z axis.

10. A method of using a mechanical arm for nut detachment and installation, the method comprising steps of:
installing the mechanical arm for nut detachment and installation according to claim 1 on a connecting rod of a clamp through a clip module;
identifying, by the visual camera, coordinates of a nut to be detached and feeding data back to the slide assembly;
driving, by the slide assembly, the detachment and installation device to move to the coordinates of the nut to be detached, and causing the detachment and installation device to be sleeved on and clamp an outer side of the nut to be detached to perform detachment;
identifying, by the visual camera, coordinates of a next nut to be detached, and repeating the above steps to cause the detachment and installation device to be sleeved on and clamp an outer side of the next nut to be detached and press the previous nut to be detached into the detachment and installation device to perform detachment;
repeating the above steps until all nuts are detached, wherein all the nuts are drawable out of the detachment and installation device; and
repeating the above steps reversely to install a nut of the nuts.
